(19) United States
(12) Patent Application Publication
(10) Pub. No.: US 2012/0090584 A1
(43) Pub. Date: Apr. 19, 2012

(54) APPARATUS AND METHOD FOR CONTROLLING LOW PRESSURE EXHAUST GAS RECIRCULATION SYSTEM

(75) Inventor: Jae Yoon JUNG, Gyeonggi-do (KR)

(73) Assignees: Kia Motors Corporation, Seoul (KR); Hyundai Motor Company, Seoul (KR)

(21) Appl. No.: 13/189,192

(22) Filed: Jul. 22, 2011

(30) Foreign Application Priority Data
Oct. 18, 2010 (KR) 10-2010-0101574

(51) Int. Cl. F02M 25/07

(52) U.S. Cl. 123/568.12

(57) ABSTRACT

An apparatus and a method for controlling a low pressure exhaust gas recirculation system has advantages including minimizing condensate water generation in an intercooler and a low pressure EGR cooler by controlling EGR gas amount through optimally mapping many control variables influencing direct factors instead of controlling the EGR gas amount according to direct factors.

### CROSS-REFERENCE TO RELATED APPLICATION

This application claims priority to and the benefit of Korean Patent Application No. 10-2010-0101574 filed Oct. 18, 2010, the entire contents of which application is incorporated herein for all purposes by this reference.

### BACKGROUND OF INVENTION

1. Field of Invention

The present invention relates to a low pressure exhaust gas recirculation (EGR) system control apparatus, and a control method thereof. More particularly, the present invention relates to a low pressure EGR system control apparatus and a control method thereof that minimizes condensate water generated by optimally mapping many control variables that influence direct factors instead of controlling the direct factors.

2. Description of Related Art

There is an EGR system that partially recirculates exhaust gas to an intake system, reduces the maximum temperature during combustion, prevents NOx from being generated, and enhances fuel efficiency in an internal combustion engine.

FIG. 1 is a drawing showing an EGR system mounted at an internal combustion engine.

Referring to FIG. 1, an EGR system is composed of a high pressure EGR system 110 that recirculates exhaust gas in the front end of a turbocharger 102 connected with an exhaust manifold of an engine 100 to an intake system, and a low pressure EGR system 120 that recirculates exhaust gas in the rear end of a catalyst converter 103 to the front end of a compressor.

The high pressure EGR system 110 includes a first EGR valve 111 that is duty-controlled according to drive conditions of an engine 100 and controls the recirculation quantity of the exhaust gas in the front end of the turbocharger 102, and a first EGR cooler 112 that cools the exhaust gas recirculated through the first EGR valve 111 and flows into an intake manifold.

Also, the low pressure EGR system 120 includes a second EGR valve 121 that is duty controlled according to drive conditions of the engine 100 and controls the recirculation quantity of the exhaust gas in the rear end of the catalyst converter 103, and a second EGR cooler 122 and a filter 123 that cools the exhaust gas recirculated through the first EGR valve 121. Fresh air is inflowed through an inlet 101, passes the turbo charger 102, and then is supplied into the engine 100 after cooled in an intercooler 104.

The second EGR valve 121 is composed of a 3-way valve such that the quantities of low pressure EGR gas and back pressure can be adjusted.

The low pressure EGR system 120 does not deteriorate the efficiency of the turbocharger under drive conditions of high-speed and high-load operation by recirculating the exhaust gas in the rear end of the turbocharger 102, and can supply a lot of exhaust gas so that a reduction of NOx and fuel consumption can be obtained.

However, the recirculated exhaust gas creates condensate water when passing the EGR cooler and an intercooler and exchanging heat, and the quantity of the condensate water is determined as follows.

Created condensate water=water vapor in exhaust gas (g)−saturated water vapor at dropped temperature (g/m^{J}) X flux of exhaust gas (m^{J})

That is, the water vapor in the low pressure EGR gas and the water in the heat exchanger operate as predominant factors to create the condensate water.

FIG. 2 is a drawing representing factors related to condensate generation of the intercooler and problems in the low pressure EGR system as various embodiments. As shown in FIG. 2, in the low pressure EGR system, indirect factors that indirectly influence the condensate water generation in the intercooler are coolant temperature, intercooler efficiency, load, fuel amount, outdoor temperature, vehicle speed, atmospheric pressure, boost pressure, relative humidity, the ratio of the low pressure EGR gas and the high pressure EGR gas, etc.

The direct factors that directly influence the condensate water generation can be the temperature of the rear end in the intercooler, flux passing through the intercooler, and inner water vapor of the operation fluid, which are influenced by the indirect factors.

Therefore, the condensate water is generated by the indirect and direct factors, and the generated condensate water in the intercooler corrodes the intercooler, causes a freezing block, damages parts in the combustion chamber, and deteriorates the exhaust gas quality.

FIG. 3 is a drawing representing factors related to the condensate water generation and problems as another exemplary embodiment in the low pressure EGR system.

As shown in FIG. 3, the indirect factors that indirectly act on the condensate water generation in the low pressure EGR cooler of the low pressure EGR system are coolant temperature, efficiency of the low pressure EGR cooler, pressure difference, load, fuel amount, outdoor temperature, vehicle speed, atmospheric pressure, boost pressure, relative humidity, the ratio of the low pressure EGR gas and the high pressure EGR, etc.

The direct factors that act on the condensate water generation in the low pressure EGR cooler can be the rear end temperature of the EGR cooler, flux passing through the low pressure EGR cooler, inner water vapor of the operation fluid, etc.

Therefore, the condensate water is generated by the indirect and direct factors in the low pressure EGR cooler, and there are a few problems such as damage to the turbocharger compressor wheel, corrosion of the low pressure EGR valve, corrosion of the low pressure EGR cooler, and blockage of a filter.

The generated condensate generated in the intercooler is stored in a reservoir tank, and when the quantity of the condensate water reaches a predetermined quantity, an electronic valve is operated such that the condensate water is automatically discharged, as described in U.S. Pat. No. 6,301,887.

Also, an additional exhaust passage to discharge the condensate water into the low pressure EGR cooler is formed such that the generated condensate water can be discharged through the exhaust pipe as described in Japan Patent Laid-Open Publication No. 2008-002351.

These conventional arts have problems that the additional systems are formed such that the total cost of the system is increased.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an apparatus and a method for controlling a low pressure exhaust gas recirculation system having advantages of minimizing condensate water generation in an intercooler and a low pressure EGR cooler by controlling low pressure EGR gas according to combinations of indirect factors that are many control variables influencing the temperatures at the rear end of an intercooler and at the rear end of the low pressure EGR cooler, the temperatures at the rear end of the intercooler and the low pressure EGR cooler, and fluxes passing through the intercooler and the low pressure EGR cooler.

Various aspects of the present invention provide for a control apparatus for a low pressure EGR system, including a driving information detector that detects information regarding direct factors and indirect factors related to condensate water generation in a low pressure EGR cooler and an intercooler, a controller that prevents the condensate water from being generated in the intercooler and the low pressure EGR cooler by applying the detected indirect factors related to the condensate water generation to a predetermined map and determining a low pressure EGR control duty, and controlling the duty of an EGR valve duty according to the conditions of the direct factors related to the condensate water generation, and a low pressure EGR valve that adjusts the low pressure EGR quantity according to a duty control signal applied in the controller.

The driving information detector can detect engine speed, coolant temperature, atmospheric pressure, outdoor temperature, vehicle speed, boost pressure, fuel amount, pressure difference of the low pressure EGR cooler, relative humidity, and a ratio of high pressure EGR and low pressure EGR as indirect factors. The driving information detector can detect the rear end temperature of the low pressure EGR cooler, flux passing the low pressure EGR cooler, inner water vapor of operation fluid, the rear end temperature of the intercooler, and flux passing the intercooler as direct factors.

The controller can determine the condensate water generation condition in the intercooler when the rear end temperature of the intercooler is less than a predetermined first reference temperature and a boost pressure is less than a first reference pressure, and then the low pressure EGR valve is closed such that the low pressure EGR gas amount can be adjusted to zero percent.

The controller can determine the condensate water generation condition in the low pressure EGR cooler when the rear end temperature of the low pressure EGR cooler is less than the predetermined first reference temperature, the pressure difference of the low pressure EGR cooler is larger than the second reference pressure, and the boost pressure is less than a third reference pressure, and then the low pressure EGR valve is closed such that the low pressure EGR gas amount can be adjusted to zero percent.

Other aspects of the present invention provide for a controlling method for a low pressure EGR system, including determining total EGR target flux as the sum total of high pressure EGR gas and low pressure EGR gas according to an engine speed and fuel amount, determining a final EGR gas amount by applying compensation according to coolant temperature, atmospheric pressure, outdoor temperature, and vehicle speed, controlling a low pressure EGR valve according to a determined ratio of the high pressure EGR and the low pressure EGR, determining whether a condensate water generation condition is met after detecting information of direct factors related to condensate water generation in an intercooler, and adjusting the low pressure EGR gas amount to zero percent by closing the low pressure EGR valve when the condensate water generation condition in the intercooler is met.

Direct factors related to the condensate water generation in the intercooler can include the rear end temperature of the intercooler and boost pressure.

The condensate water generation condition in the intercooler can be that the rear end temperature of the intercooler is less than a first reference temperature and simultaneously boost pressure is less than a first reference pressure.

Still other aspects of the present invention provide for a controlling method for a low pressure EGR system, including determining total EGR target flux determined as the sum total of high pressure EGR gas and low pressure EGR gas according to engine speed and fuel amount, determining a final EGR gas amount by applying compensation according to coolant temperature, atmospheric pressure, outdoor temperature, and vehicle speed, controlling a low pressure EGR valve according to a determined ratio of the high pressure EGR and the low pressure EGR, determining whether a condensate water generation condition is met after detecting information of direct factors related to the condensate water generation in a low pressure EGR cooler, and adjusting the low pressure EGR gas to zero percent by closing the low pressure EGR valve when the condensate water generation condition in the low pressure EGR cooler is met.

Direct factors related to the condensate water generation in the low pressure EGR cooler can include the rear end temperature of the low pressure EGR cooler, pressure difference of the low pressure EGR cooler, and boost pressure.

The condensate water generation condition in the low pressure EGR cooler can be that the rear end temperature of the low pressure EGR cooler is less than a first reference temperature, a pressure difference of the low pressure EGR cooler is larger than a second reference pressure, and simultaneously boost pressure is less than a third reference pressure.

In this way, according to various aspects of the present invention, durability of parts in an engine including an intercooler, a turbocharger, an LP-EGR cooler, an LP-EGR valve, and a combustion chamber can be improved by optimally mapping many control variables that influence the direct factors and controlling the EGR gas, resulting in minimizing the condensate water generation so that the reliability and the stability can be provided.

Also, the LP-EGR valve is optimally controlled such that enhancement of fuel efficiency and NOx reduction can be obtained.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 a drawing illustrating an exemplary EGR system applied to an internal combustion engine.

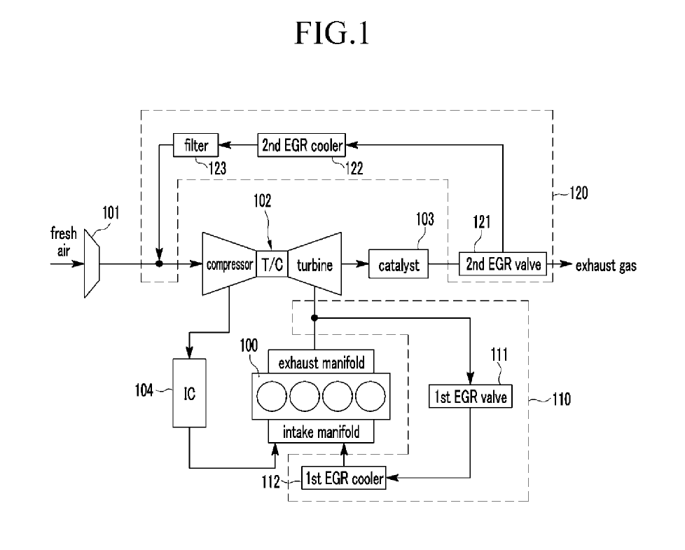

FIG. 2 is a drawing representing exemplary factors related to condensate generation of the intercooler and problems in an exemplary low pressure EGR system.

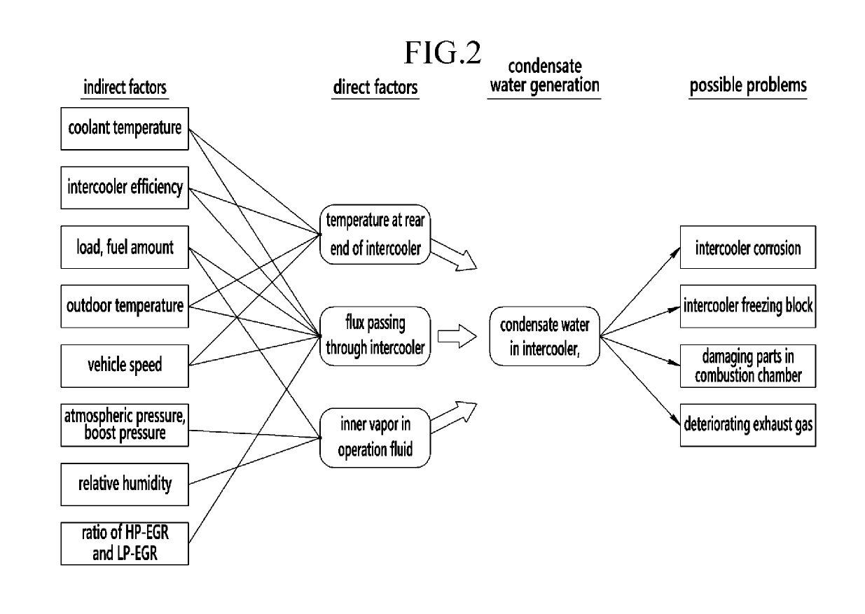

FIG. 3 is a drawing representing factors related to the condensate water generation and problems in an exemplary low pressure EGR system.

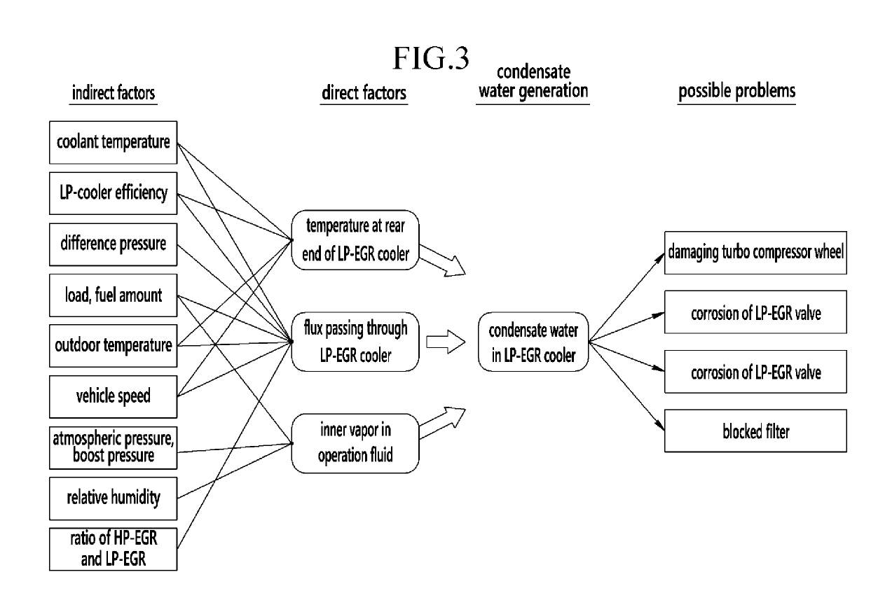

FIG. 4 is a drawing illustrating an exemplary low pressure EGR system control apparatus according to the present invention.

FIG. 5 is a flowchart showing control procedures of an exemplary low pressure

EGR system according to the present invention.

FIG. 6 is a flowchart showing control procedures of an exemplary low pressure EGR system according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

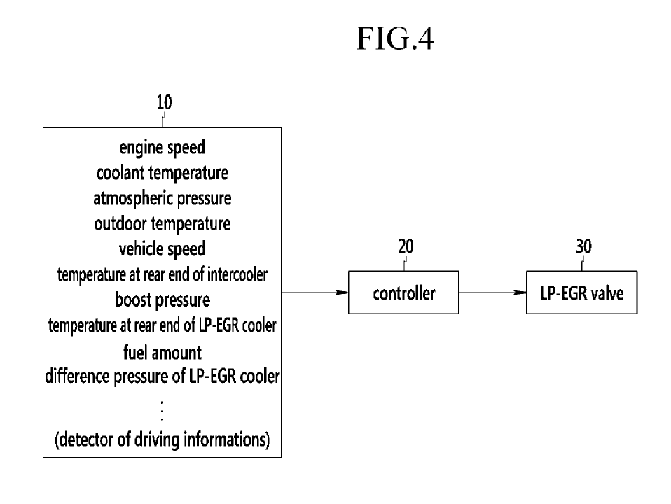

Referring to FIG. 4, the low pressure EGR system according to various embodiments of the present invention includes a driving information detector 10, a controller 20, and a low pressure EGR valve 30.

The driving information detector 10 detects information regarding direct factors and indirect factors related to condensate water generation in the low pressure EGR system according to driving, and provides them to the controller 20.

The driving information detector 10 detects information regarding engine speed, coolant temperature, atmospheric pressure in a driving region, outdoor temperature in a driving region, vehicle speed, boost pressure of a turbocharger, fuel amount, pressure difference of a low pressure EGR cooler, relative humidity, the ratio of a high pressure EGR gas and a low pressure EGR gas, etc., that act as indirect factors to cause condensate water generation in the LP-EGR system.

Also, the driving information detector 10 detects information regarding the rear end temperature of the LP-EGR cooler, flux passing through the LP-EGR cooler, inner vapor of the operation fluid, the rear end temperature of the intercooler, and flux passing through the intercooler that act as direct factors to cause condensate water generation in the LP-EGR system.

The controller 20 extracts optimum control values from the predetermined map according to many control variables, which are indirect factors applied from the driving information detector 10, such as coolant temperature, atmospheric pressure, load, fuel amount, vehicle speed, outdoor temperature, boost pressure, and the ratio of the LP-EGR gas and HP-EGR gas.

The LP-EGR valve 30 is duty controlled by the extracted control values in various combinations from direct factors such as the rear end temperature of the intercooler, flux passing through the intercooler, the rear end temperature of the LP-EGR cooler, and flux passing through LP-EGR cooler such that the condensate water in the intercooler and the LP-EGR cooler is not generated.

The LP-EGR valve 30 is opened/closed according to the duty control signal applied from the controller 20 and adjusts the LP-EGR gas amount.

The operation of the LP-EGR system including the described functions according to various embodiments of the present invention is carried out as follows.

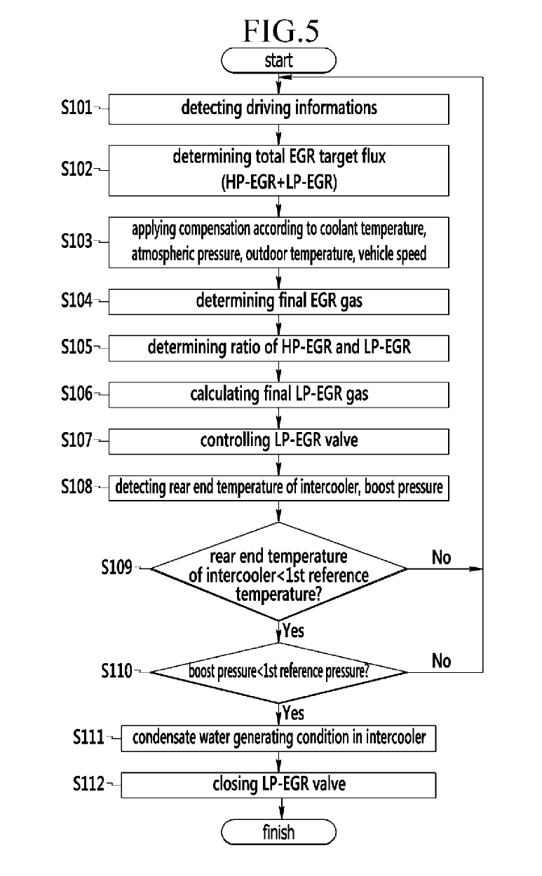

With reference to FIG. 5, a flowchart shows control procedures of the low pressure EGR system according to various embodiments of the present invention, wherein the procedures minimize the generation of the condensate water. If a vehicle applied with the present invention starts driving, the driving information detector 10 detects all the driving information regarding the indirect factors related to the condensate water generation of the intercooler in the LP-EGR system and applies the information to the controller 20 (S101).

At this time, the controller 20 determines the total EGR target flux amount with the sum of the LP-EGR gas and the HP-EGR gas while applying the engine speed and fuel amount (S102).

The controller 20 determines the final EGR gas amount (S104) by applying compensation according to a predetermined map by coolant temperature, atmospheric pressure, outdoor temperature, and vehicle speed (S103).

When the amount of the final EGR gas is determined according to drive conditions as above, the controller 20 determines the ratio of the HP-EGR gas vs. the LP-EGR gas (S105) and calculates the final LP-EGR gas amount (S106).

The controller 20 then controls the LP-EGR valve 30 and a throttle valve by duty control so that the calculated final LP-EGR gas amount can be followed (S107).

When the final LP-EGR gas amount is followed by controlling the LP-EGR valve 30 as above, the controller 20 detects the rear end temperature of the intercooler and boost pressure from the driving information detector 10 (S108), and determines whether the rear end temperature of the intercooler is less than a predetermined first reference temperature to determine the condensate water generation amount (S109).

If the rear end temperature of the intercooler is higher than the predetermined first reference temperature in the S109 determination, the controller 20 determines that the condensate water is not generated in the intercooler and the procedure is returned to step S101.

However, if the rear end temperature of the intercooler is less than the predetermined first reference temperature in the S109 determination, the controller 20 determines that the condensate water can be generated and then determines whether the boost pressure is less than a predetermined first reference pressure (S110).

If the boost pressure is higher than the predetermined first reference pressure in the S110 determination, the controller 20 determines that the condensate water is not generated in the intercooler and the procedure is returned to step S101.

However, if the boost pressure is higher than the predetermined first reference pressure in the S110 determination, the controller 20 determines that the condensate water can be generated in the intercooler (S111).

Therefore, the controller 20 determines the LP-EGR gas amount to be zero percent in order for the condensate water to not be generated in the intercooler, closes the LP-EGR valve 30 by duty control, and raises the intercooler temperature so that the condensate water cannot be generated in the intercooler (S112).

As described above, in various embodiments of the present invention, the possibility of the condensate water generation in the intercooler is determined by applying the rear end temperature of the intercooler and the boost pressure, and then the LP-EGR gas amount is controlled accordingly so that damage to the engine parts due to the condensate water generation cannot be produced.

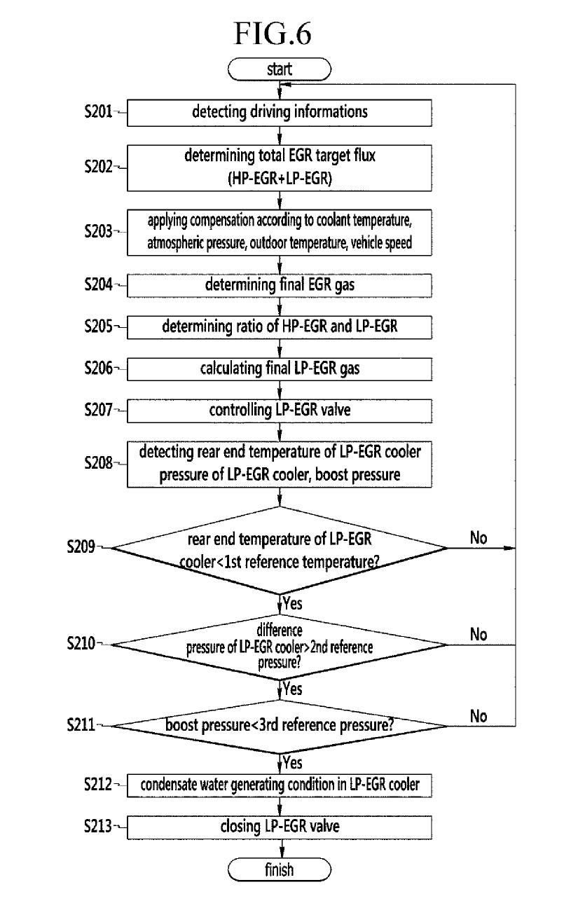

With reference to FIG. 6, a flowchart shows control procedures of the low pressure EGR system according to various embodiments of the present invention, wherein the procedures minimize the generation of the condensate in the LP-EGR cooler.

If a vehicle applied with the present invention starts driving, the driving information detector 10 detects all the driving information regarding indirect factors related to the condensate water generation in the LP-EGR cooler and applies the information to the controller 20 (S201).

At this time, the controller 20 determines total EGR target flux amount with the sum of the HP-EGR gas and the LP-EGR gas applying the engine and fuel amount (S202).

And the controller 20 determines the final EGR gas amount (S204) by applying compensation according to a predetermined map by coolant temperature, atmospheric pressure, outdoor temperature, and vehicle speed (S203).

When the amount of the final EGR gas is determined according to drive conditions as above, the controller 20 determines the ratio of the HP-EGR gas vs. LP-EGR gas (S205) and calculates the final LP-EGR gas amount (S206).

The controller 20 then controls the LP-EGR valve 30 and a throttle by duty control so that the calculated final LP-EGR amount gas can be followed (S207).

When the final LP-EGR gas amount is followed by controlling the LP-EGR valve 30 as above, the controller detects the rear end temperature of the LP-EGR cooler, pressure difference of the LP-EGR cooler, and boost pressure from the driving information detector 10 (S208).

The controller 20 determines whether the rear end temperature of the LP-EGR cooler is less than the predetermined first reference temperature to determine the condensate water generation amount (S209).

If the rear end temperature of the LP-EGR cooler is higher than the predetermined first reference temperature in the S209 determination, the controller 20 determines that the condensate water is not generated in the LP-EGR cooler and the procedure is returned to step S201.

However, if the rear end temperature of the LP-EGR cooler is less than the predetermined first reference temperature in the S209 determination, the controller 20 determines that the condensate water can be generated in the LP-EGR cooler, compares the pressure difference of the LP-EGR cooler with the predetermined second reference pressure, and determines whether the pressure difference of the LP-EGR cooler is larger than the second reference pressure (S210).

If the pressure difference of the LP-EGR cooler is less than the predetermined second reference pressure in the S210 determination, the controller 20 determines that the condensate water is not generated in the LP-EGR cooler, and the procedure is returned to step S201.

However, if the pressure difference of the LP-EGR cooler is higher than the predetermined second reference pressure in the S210 determination, the controller 20 determines that the condensate water can be generated in the LP-EGR cooler, and determines whether the boost pressure is less than a predetermined third reference pressure (S211).

If the boost pressure is higher than the predetermined third reference pressure in the S211 determination, the controller 20 determines that the condensate water is not generated in the LP-EGR cooler and the procedure is returned to step S201.

However, if the boost pressure is less than the predetermined third reference pressure in the S211 determination, the controller 20 determines that the condensate water can be generated in the LP-EGR cooler (S212).

Therefore, the controller 20 determines the LP-EGR gas amount to be zero percent in order for the condensate water to not be generated in the LP-EGR cooler, closes the LP-EGR valve 30 by duty control, and adjusts the flux of the LP-EGR cooler so that the condensate water cannot be produced (S213).

As described above, in various embodiments of the present invention, the possibility of the condensate water generation in the LP-EGR cooler is determined by applying the rear end temperature of the LP-EGR cooler, the pressure difference of the LP-EGR cooler, and the boost pressure, and then the LP-EGR gas amount is controlled accordingly so that damage to the engine parts due to the condensate water generation cannot be produced.

For convenience in explanation and accurate definition in the appended claims, the terms front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A control apparatus for a low pressure exhaust gas recirculation (EGR) system, comprising:
a driving information detector that detects information regarding direct factors and indirect factors related to condensate water generation in a low pressure EGR cooler and an intercooler;
a controller that prevents condensate water from being generated in the intercooler and the low pressure EGR cooler by applying the detected indirect factors related to the condensate water generation to a predetermined map and determining a low pressure EGR control duty, and controlling the duty of an EGR valve duty according to the conditions of the direct factors related to the condensate water generation; and
a low pressure EGR valve that adjusts a low pressure EGR quantity according to a duty control signal applied in the controller.

2. A control apparatus of claim 1, wherein the driving information detector detects as indirect factors one or more of engine speed, coolant temperature, atmospheric pressure, outdoor temperature, vehicle speed, boost pressure, fuel amount, pressure difference of the low pressure EGR cooler, relative humidity, and a ratio of high pressure EGR and low pressure EGR.

3. A control apparatus of claim 1, wherein the driving information detector detects as direct factors one or more of the rear end temperature of the low pressure EGR cooler, flux passing the low pressure EGR cooler, inner water vapor of operation fluid, the rear end temperature of the intercooler, and flux passing the intercooler.

4. A control apparatus of claim 1, wherein the controller determines the condensate water generation condition in the intercooler when the rear end temperature of the intercooler is less than a predetermined first reference temperature and a boost pressure is less than a first reference pressure, and then the low pressure EGR valve is closed such that low pressure EGR gas amount is adjusted to zero percent.

5. A control apparatus of claim 1, wherein the controller determines the condensate water generation condition in the low pressure EGR cooler when the rear end temperature of the low pressure EGR cooler is less than a predetermined first reference temperature, a pressure difference of the low pressure EGR cooler is larger than a second reference pressure, and a boost pressure is less than a third reference pressure, and then the low pressure EGR valve is closed such that the low pressure EGR gas amount is adjusted to zero percent.

6. A controlling method for a low pressure exhaust gas recirculation (EGR) system, comprising:
determining total EGR target flux as the sum total of high pressure EGR gas and low pressure EGR gas according to an engine speed and fuel amount;
determining final EGR gas amount by applying compensation according to coolant temperature, atmospheric pressure, outdoor temperature, and vehicle speed;
controlling a low pressure EGR valve according to a determined ratio of the high pressure EGR and the low pressure EGR;
determining whether a condensate water generation condition is met after detecting information of direct factors related to condensate water generation in an intercooler; and
adjusting the low pressure EGR gas amount to zero percent by closing the low pressure EGR valve when the condensate water generation condition in the intercooler is met.

7. A controlling method of claim 7, wherein direct factors related to the condensate water generation in the intercooler comprise the rear end temperature of the intercooler and boost pressure.

8. A controlling method of claim 7, wherein the condensate water generation condition in the intercooler is that the rear end temperature of the intercooler is less than a first reference temperature and simultaneously boost pressure is less than a first reference pressure.

9. A controlling method for a low pressure exhaust gas recirculation (EGR) system, comprising:
determining total EGR target flux as the sum total of high pressure EGR gas and low pressure EGR gas according to engine speed and fuel amount;
determining a final EGR gas amount by applying compensation according to coolant temperature, atmospheric pressure, outdoor temperature, and vehicle speed;
controlling a low pressure EGR valve according to a determined ratio of the high pressure EGR and the low pressure EGR;
determining whether a condensate water generation condition is met after detecting information of direct factors related to the condensate water generation in a low pressure EGR cooler; and
adjusting the low pressure EGR gas amount to zero percent by closing the low pressure EGR valve when the condensate water generation condition in the low pressure EGR cooler is met.

10. A controlling method of claim 9, wherein direct factors related to the condensate water generation in the low pressure EGR cooler comprise the rear end temperature of the low pressure EGR cooler, pressure difference of the low pressure EGR cooler, and boost pressure.

11. A controlling method of claim 9, wherein the condensate water generation condition in the low pressure EGR cooler is that the rear end temperature of the low pressure EGR cooler is less than a first reference temperature, a pressure difference of the low pressure EGR cooler is larger than a second reference pressure, and simultaneously boost pressure is less than a third reference pressure.
